(19) United States
(12) Patent Application Publication
(10) Pub. No.: US 2004/0074735 A1
(43) Pub. Date: Apr. 22, 2004

(54) Storage roller

(76) Inventor: Chi-Da Lu, SanChung City (TW)

Correspondence Address: CHARLES E. BAXLEY, ESQUIRE, Third Floor, 90 John Street, New York, NY, 10038, US

(21) Appl. No.: 10/455,585

(22) Filed: Jun. 4, 2003

(30) Foreign Application Priority Data
Oct. 18, 2002 (TW) 091124049

(51) Int. Cl. B65G 13/00

(52) U.S. Cl. 193/37

(57) ABSTRACT

A storage roller is disclosed for storing a soft object, such as papers, blueprints, drawing papers, clothes, sporting mats, and etc. The storage roller includes a bar and a fin. The fin guides the soft object to be winding along the outer of the bar. It provides to carry the soft object easily and protects the soft object from folding.

### BACKGROUND OF THE INVENTION

1. Field of Invention

The present invention relates to a storage roller, and, more particularly, to a roller storing the soft object, likes papers, clothes, sporting mats and so on, by winding.

2. Related Art

Due to the increasing of the creation of human beings, it creates more and more kits to improve the quality of life. However it's a problem to store the kits efficiently. Take soft objects for example, such as papers, clothes, sporting mats and so on, as follows.

For A4 size papers, 210 mm*297 mm in dimension, it's easy to carry due to the small size. But for full size blueprints, 760 mm*1060 mm in dimension, it's difficult to carry under the unfolded. And the clothes, such as canvas or artistic productions, face the same problem. The sporting mats, likes yoga mats, are made of plastic-vesicant material. It's very soft and elastic to reduce the impact due to sport. Owing to its material, it's hard to fold them. It's usually wrapped in cylinder-shaped by hands. But they would occupy very much space and hard to carry.

What is needed is a apparatus for storing the soft object easily and efficiently.

### SUMMARY OF THE INVENTION

It is therefore an object of the present invention, which provides a storage roller to store soft object, such as papers, blueprints, drawing papers, clothes, sporting mats, and etc. by winding in minimization storing space and easy using.

To achieve the object in accordance with the present invention, there is provided a storage roller including a bar and a fin. The bar can store the soft object by winding. And the fin can guide the soft object along the bar easily when beginning to store.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below illustration only, and thus are not limitative of the present invention, and wherein:

FIG. 1 is a perspective view illustrating the storage roller of this invention;

FIG. 2 is a explosive view of the storage roller; and

FIGS. 3 and 4 are sectional views of FIG. 1 illustrating the use of storing a soft object.

### DETAILED DESCRIPTION OF THE INVENTION

Hereinafter, the invention will be described in greater detail with reference to the preferred embodiments. However, it is understood that the roller is applicable for the storage of any soft object known in the art.

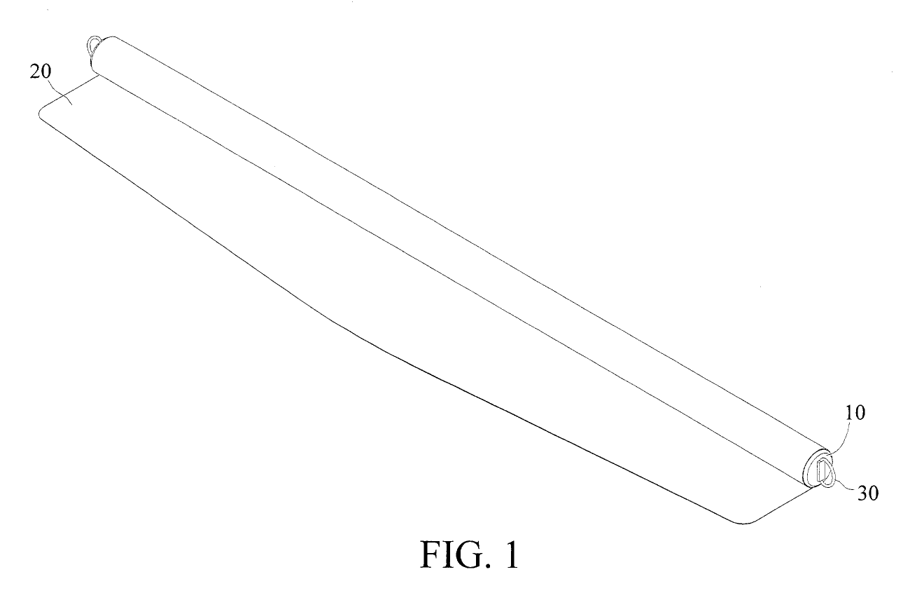

As shown in FIG. 1, the storage roller according to this invention includes a bar 10, a fin 20 and a buckle 30.

The bar 10 winds a soft object, such as papers, blueprints, drawing papers, clothes, sporting mats, and etc. on its surface. And at the beginning of storing, the fin 20 guides the soft object to be wound on the bar 10.

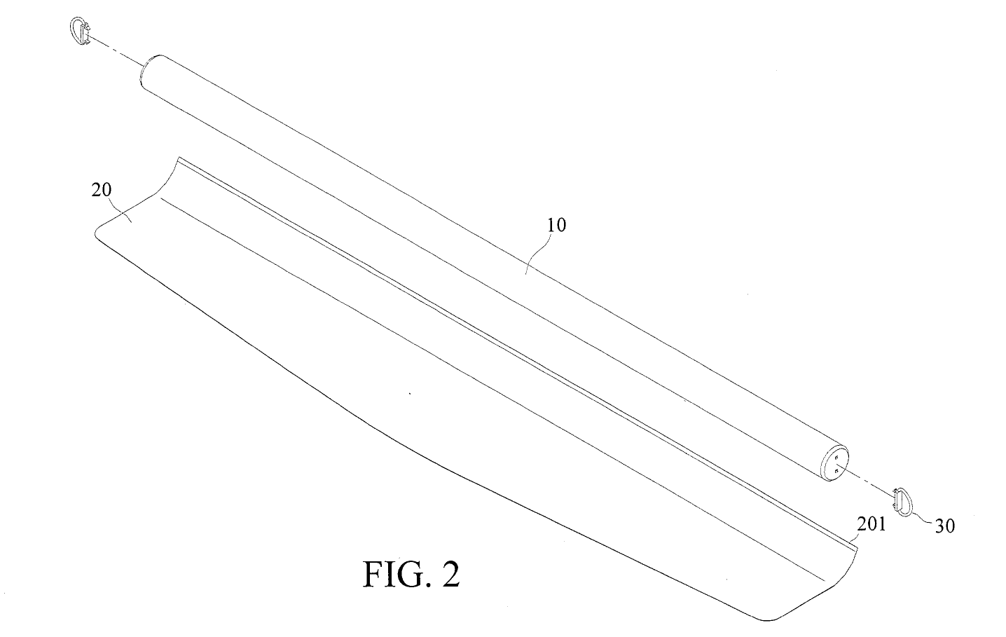

The bar 10 is cylinder-shaped, and the rear of the fin 20 connects to the outer surface of bar 10. The fin 20 is geometric-shaped and made of flexible material. And the fin 20 further includes a connecting portion 201 and a front portion 202. The connecting portion 201 installs in the rear of the fin 20 for connecting to the outer surface of the bar 10 (FIGS. 1 and 2) and covering the bar 10. The front portion 202 is used to guide the stored soft object. And the buckle 30 is mounted on the both sides of the bar 10. It provides users to connect a belt. By the belt, the user can carry the soft object on the back rather than take it on the hand.

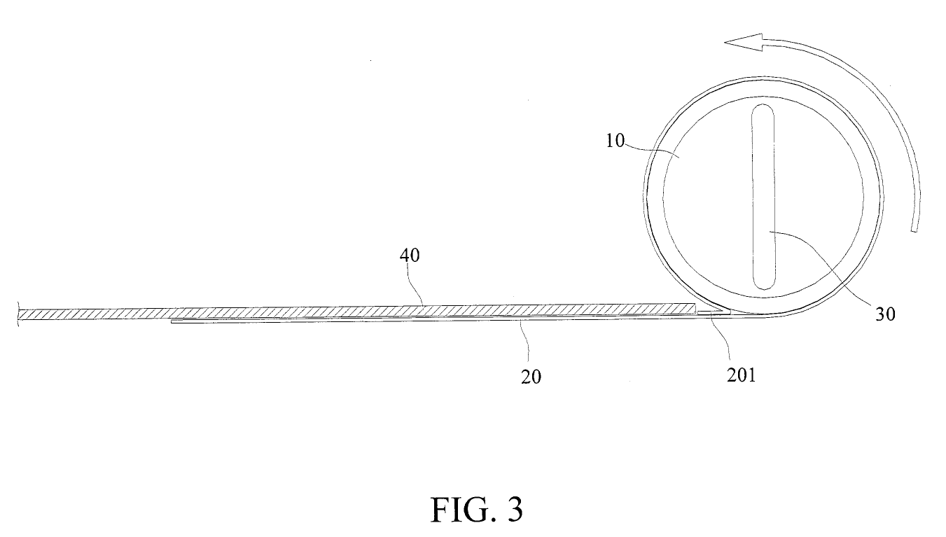

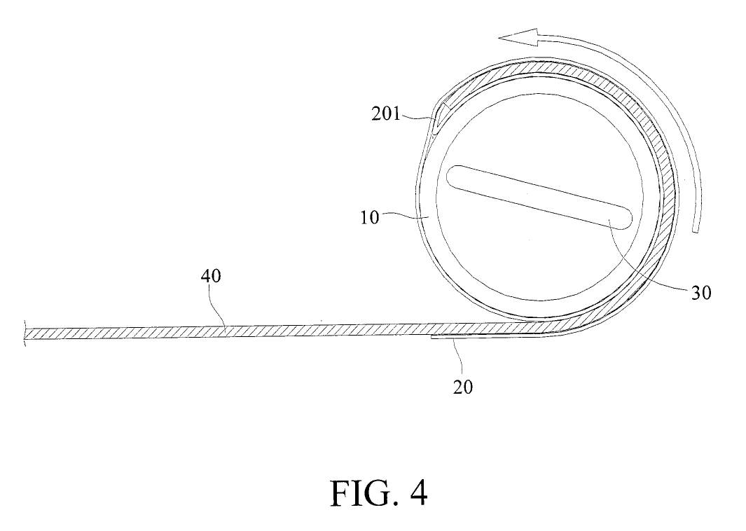

As illustrated in FIGS. 3 and 4, showing the use of storing a soft object.

First, putting the soft object 40, which wants to be stored, on a plane uniformly. Then guiding the fin 20 of the storage roller below soft object 40, and rolling the bar forward (FIG. 3). When the bar 10 rotates, it takes the fin 20 along the outer surface of the bar 10 and clips the soft object 40 uniformly by the friction between the bar 10 and the fin 20 (FIG. 4). Finally, the soft object 40 is wound circled along the bar 10 from inside to outside. And it also can change the material of the bar 10 and the fin 20 to corresponding to the material of the soft object 40 to increase the efficient of storage.

According to the storage roller of this invention, it can store a soft, hard-stored object, likes papers, blueprints, drawing papers, clothes, sporting mats, and etc., easily and efficiently. After storing, the storage roller also protects the soft object, such as papers, blueprints and drawing papers, from folding by the compressing force. It stores the elastic-soft object, such as sporting mats and etc., more compact to save the space of storage. And even the soft object is stored in cylinder-shaped, it can unwind quickly by the storage roller of this invention. Although the soft object may be curly on its corner, it can return flatly by winding counter to the original direction. And it is easy to carry by the design of the buckle.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A storage roller for storing a soft-planed object, comprising:
a bar, being cylinder-shaped, winding said object along the outer surface of said bar; and
a fin, being geometric-shaped and made of flexible material, connecting to the outer surface of said bar and covering the bar;
wherein said fin guides the object to be clipped between said bar and said fin and cover along the outside of said bar.

2. The storage roller of the claim 1, wherein the fin comprising:
a connection portion, set on the rear of said fin to connect to said bar; and
a front portion, set on the front of said fin for guiding said object.

3. The storage roller of the claim 1, wherein the bar including a buckle on its one side to mount a belt for carrying.

4. The storage roller of the claim 1, wherein said soft-planed object is a paper.

5. The storage roller of the claim 1, wherein said soft-planed object is a sporting-mat.

6. The storage roller of the claim 1, wherein said soft-planed object is a clothes.
